(19) United States
(12) Patent Application Publication
(10) Pub. No.: US 2018/0236650 A1
(43) Pub. Date: Aug. 23, 2018

(54) Extendable four tiered open end wrench set

(71) Applicant: Thomas Carnesi, Torrance, CA (US)

(72) Inventor: Thomas Carnesi, Torrance, CA (US)

(21) Appl. No.: 15/530,723

(22) Filed: Feb. 21, 2017

(51) Int. Cl. B25G 1/08; B25B 13/08; B25B 23/00

(52) U.S. Cl. CPC B25G 1/085; B25B 23/0007; B25B 13/08

(57) ABSTRACT

A wrench set comprising a plurality of different sized wrenches, each of which are horizontally slideable from right to left within a cylindrically elongated upper and lower handle housing. A user selects a particular tiered wrench by rotation of the outer cylindrical, knurled, collar to select a particular tiered wrench while simultaneously sliding the cylindrical collar either in a forward or reverse longitudinal direction, depending on the wrench socket end size desired. The extended wrench is then locked in that extended working position.

While the invention has been described with reference to its preferred embodiments, it will be fully understood by those skilled in the art that various changes may occur to adapt a particular situation and or material to the teachings of this invention without departing from its essential teachings.

### BACKGROUND OF THE INVENTION

### 1. Field of the Invention

The present inventions provides a slideable forward and reverse open-end set of four wrenches that are tiered and retractable when not in use.

### 2. Description of the Prior Art

The concept of having a single wrench tool having the capability of operating on hexagonal nuts and bolts of various diameters have been disclosed in prior art. For example, U.S. Pat. No. 8,387,489 to Hsu is typical of such devices and discloses a multi-size ratchet wrench which includes a handle having two ends, at least one of which forms a head that receives and retains therein a fitting assembly that affects single direction driving. The fitting assembly supports a rotatable block that has a rotational axis (substantially) perpendicular to a rotational axis of the fitting assembly. The rotatable block has a circumferential surface forming one or multiple fitting sections that are substantially normal to the rotational axis of the rotatable block allowing a user to select among differently sized fitting sections through direct rotation of the rotatable block.

Although the Hsu patent describes a wrench that reduces the number of sockets that one need to carry when a repair or installation is required, the mechanism required is expensive to fabricate and depends upon the life and reliability of the rotational block.

What is desired is to provide a wrench that avoids the disadvantages of prior art, multiple socket wrenches of the type disclosed by Hsu.

### SUMMARY OF THE INVENTION

The present invention provides a compact, slideable and stackable flat open end wrench set having a first tier wrench with a 5/16 inch socket end, the opposite end having ⅜ socket end; a second tier wrench having a ½ inch socket at one end and a 7/16 on the opposite end: a third tier wrench having a ⅝ inch socket at one end and a 9/16 inch open end at the opposite end; a fourth tiered wrench having a ¾ inch end and its opposite end having an 11/16 inch socket end.

The four tiered wrenches and are set within an upper and lower cylindrical housing halves for loosening and tightening hexagonal type fasteners of various sizes. The four tiered wrenches are retained within the cylindrical housing halves being supported by a central guide pillar. Each stacked wrench has a longitudinal channel that rides on and is guided by the central support pillar and an exterior collar. The stacked wrenches can either be slid forward for that selected size or reverse for the opposite end selection, and retracted to a neutral position within the cylindrical housing when not used.

There is a wrench selecting exterior knurled collar that is axially rotatable in a clockwise or counter clock wise rotation with the aid of an exterior guide pin The guide pin also axially rides within a centrally located grooved track that is imbedded in a crosswise position centrally at the bottom cylindrical handle half; the user axially rotates the collar to select a particular size tiered wrench needed by axial rotation, and then simultaneously sliding the collar in either a forward or reverse extended direction depending on the size of the wrench needed.

The exterior knurl collar also has an internal affixed cam configured arm that captures the crosswise notch of the any of the four tiered wrench arms at their right side mid location during axial rotation; the user then simultaneously slides the collar either forward or reverse direction longitudinally and thus influencing a selected size wrench need to be locked in the extended position.

Each wrench has its own tiered détente notch in three places; they are positioned within their longitudinal channel. The central détente notch keeps each wrench positioned in a central or parked position when they are not in use; the outer or extreme two notches, forward and aft., are for restraining the wrenches when extended outward for use in either of their working direction. There are four tiered spring induced spherical steel balls that are set with in the central pillar they lock in place each individual tiered wrench at their détente notches within their longitudinal channel. The spring induced steel spherical ball bearings (four tiered) capture the tiered wrenches at their recessed radius configured notches to constrain each tiered wrench during their selected operation.

This tool set assembly is quite inexpensive to manufacture, it solves many problems that a consumer may encounter such as misplacing or losing individual wrenches; and is ideally suited for the handy person or the sports enthusiast for whom space saving and compactness of a tools is important.

### DESCRIPTION OF THE DRAWINGS

For better understanding of the present invention as well as other objects and further features thereof, reference is made to the following description which is to be read in conjunction with the accompanying drawings wherein:

FIG. 1 is an ISO view of the slide wrench set of the present invention 10;

FIG. 2 is an exploded ISO view of the wrench set components in 10 FIG. 1;

FIG. 3 is a bottom view of the present invention 10 with the one wrench 16a or ½ size opening extended for use, and its longitudinal track where the slide ring is located to represent the wrench selected and representing the teachings of the present invention;

FIG. 4 is a side view of the present invention 10 with the selecting wrench sizes 14a or ½ size extended representing the teachings of the present invention;

FIG. 5 is a top view of the present invention 10 showing the adjusting longitudinal guide indicia handle half, the cylindrical collar 24 longitudinally moved to extend wrench 14a with the teachings of the present invention;

FIG. 6 is an end view of the present invention 10 showing one end of lone stacked wrench 14a, extended with the teachings of the present invention;

FIG. 7a is a detailed enlarged view of size indicia 11/16, 9/16, 7/16 and 5/16 size on the upper wrench half embodiment;

FIG. 7b is a detailed enlarged view size indicia ⅜, ½, ⅝ and ¾ sizes on the upper wrench half embodiment;

FIG. 8 is a bi-lateral, mid, cross section view of the wrench set showing the wrench ends 18a (¾), 16a (⅝), 14a (½) and 12a (⅜) wrench openings of the tiered wrenches, the central support pillar and the upper and lower housing exterior channel features collar profiles;

FIG. 9 is a right side profile view of the upper and lower handle halves;

FIG. 10 is a bottom view of the lower handle half showing the four longitudinal guide tracks that represent each wrench size, and the bi-lateral central groove where the selecting collar rotates axially with the aid of the trace pin;

FIG. 11 is a detailed, longitudinal hatch view, of the upper and lower half round handle along B-B longitudinal mid-section shown on FIG. 10;

FIG. 12 is a mid bi-lateral hatch view, along C-C, on FIG. 10 of both the upper and lower handle halves profile;

FIG. 13 is bi-lateral cross section hatch views of both the upper and lower handle halve profile showing the angular orientation of the longitudinal wrench selecting tracks;

FIG. 14 is an isometric view of the of slide wrenches' upper and lower halves;

FIG. 15 is an enlarged top view of the adjusting collar sub-assembly;

FIG. 16 is an enlarged bi-lateral cross section view along section B-B showing the collar profile, the angular orientation of the slideable guide pins and the internal wrench selecting arm;

FIG. 17 is an enlarged view of the size indicia selector mark;

FIG. 18 is an isometric view of the lower cylindrical collar;

FIG. 19 is a top view of the lower cylindrical handle sub-assembly which shows the selecting cylindrical collar extending wrench 18b ( 11/16) to the right side and exposing the central support pillar;

FIG. 20 is a top view of the of lower handle, and the cylindrical collar and wrench 18a and 18b sub-assembly in a central or neutral position;

FIG. 21 is a top view of the lower cylindrical handle sub-assembly which shows the selecting cylindrical collar extending wrench 18a (¾) to the left side and exposing the central support pillar;

FIG. 22 is a cross section bi-lateral hatched view of then cylindrical collar profile, the support pillar with the four tiered vertical holes 32a, wrench support inserts 28a and 28b, 18a and 18b wrench and the cylindrical collars' internal cam 26 to capture a selected stacked wrench.

### DESCRIPTION OF THE INVENTION

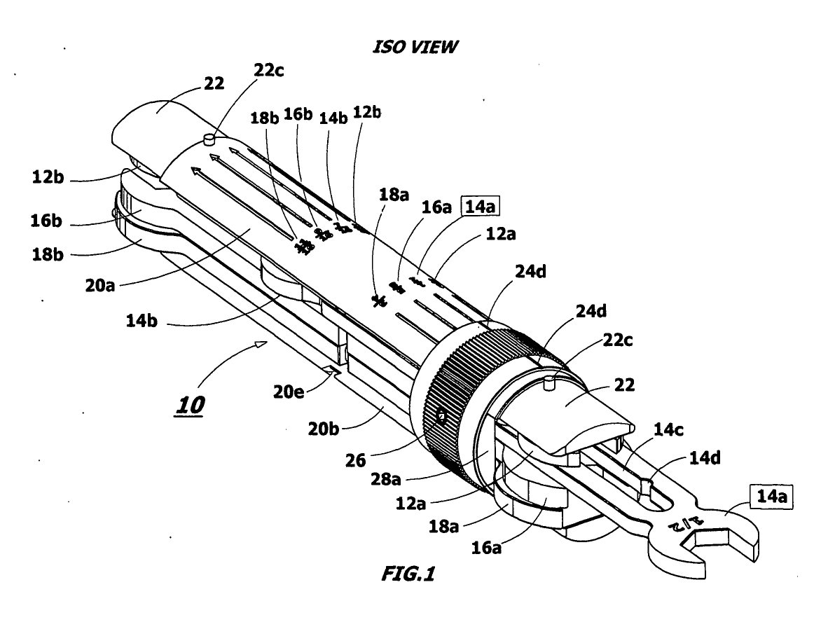

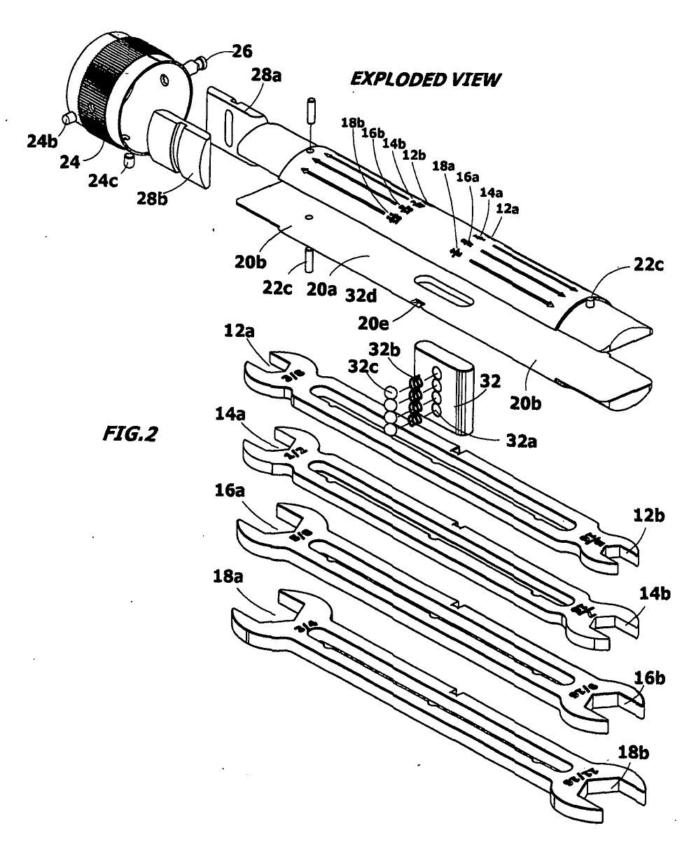

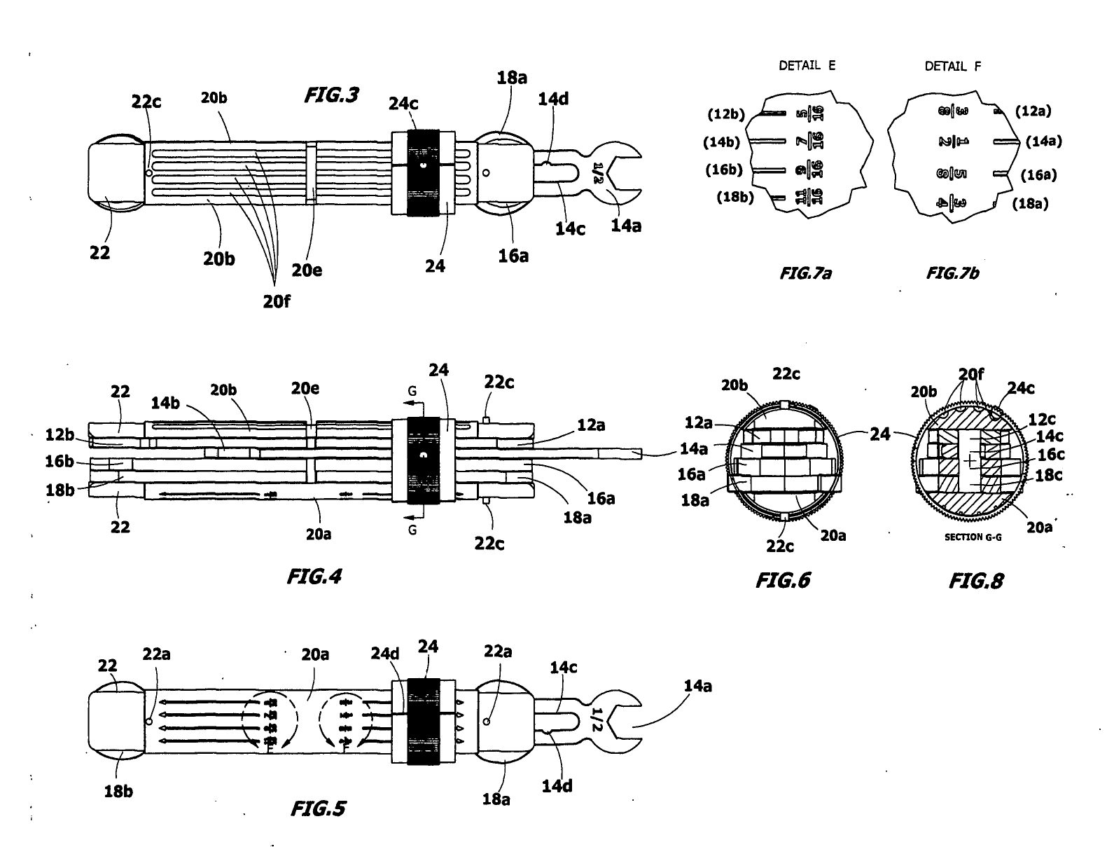

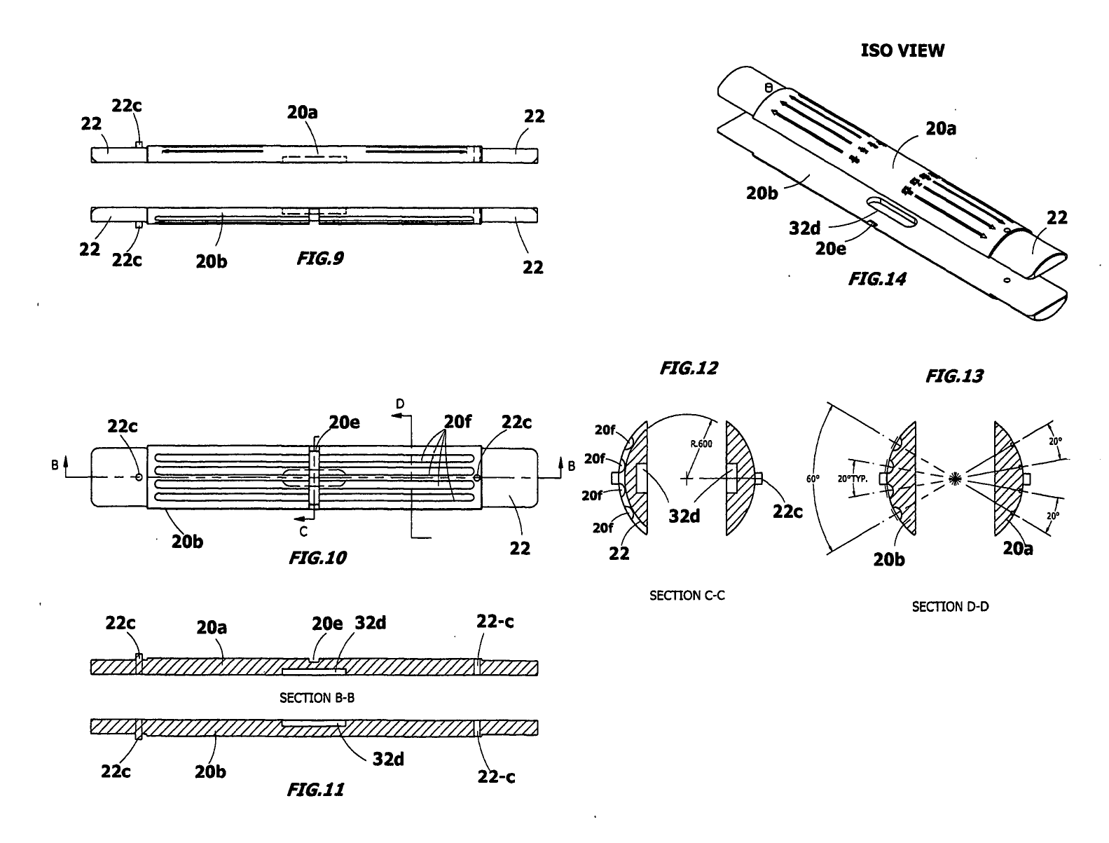

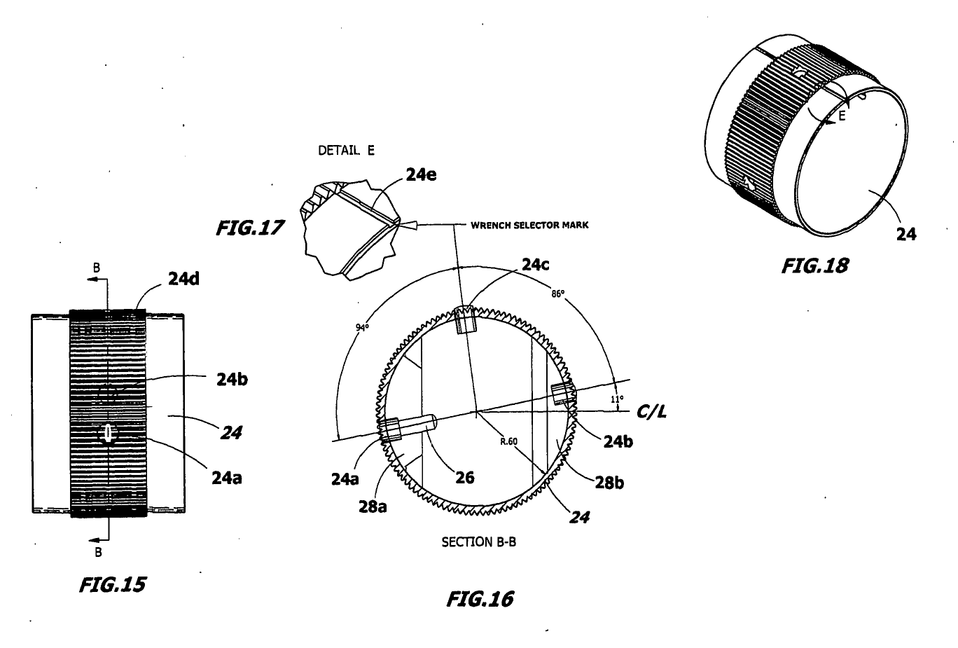

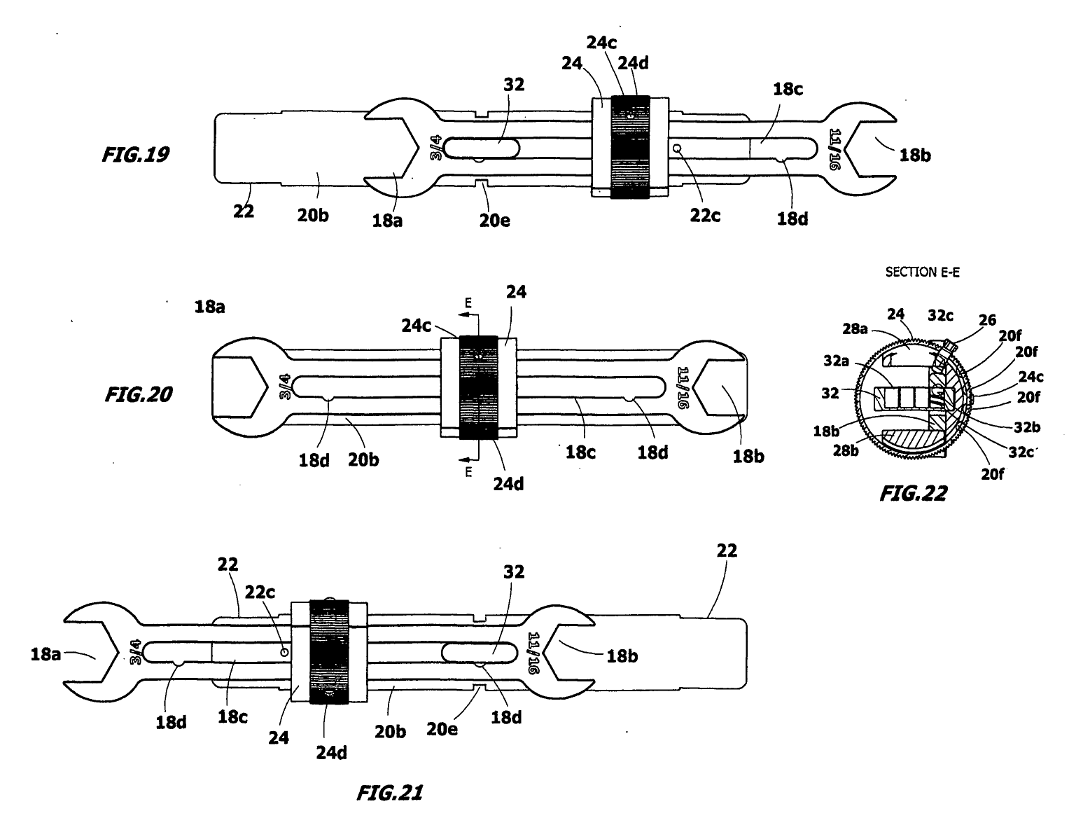

FIG. 1 is an isometric view of wrench set 10 of the present invention. Wrench set 10 comprises four flat wrenches 12a/b, 14a/b, 16a/b and 18a/b that are manually slideable in a longitudinal direction. Each individual wrench has two open end sizes; the smallest tier slideable wrench 12b has a 5/16 inch opening at one end, and its opposite end has a ⅜ a inch hex socket opening; the second tiered wrench 14b has 7/16 at one end 14a, is a ½ opening at its opposite end; the third tiered wrench 16a has a ⅝ inch hex socket opening and a its opposite end has a 9/16 inch opening 16b at its opposite end; the fourth tiered wrench 18a has a ¾ inch opening at one end and 18b is an 11/16 inch opening at its opposite end. (It is to be noted that other wrenches such as, closed end (6 or 12 point sizes) can be formed as part of the wrench set.

Each individual wrench 12, 14, 16 and 18 has a longitudinal slotted channel 12c, 14c, 16c and 18c, respectively, slide longitudinally in either a forward or reversed direction within the length distance of channels 12c, 14c, 16c and 18c; each selected wrench has a mid-cross section notch on 12e, 14e, 16e and 18e its right side where the internal cam arm 26 of the cylindrical selecting collar 24; cam arm 26 of collar 24 captures the selected tiered wrench during the collar axial rotation that a particular wrench the user selects. The four tiered wrenches 12, 14, 16 and 18 are housed within the cylindrical housing 20a and 20b halves. A reduced end diameter 22 at both ends of the cylindrical halves enhances the working area and appeal of the four tiered individual wrenches 12, 14, 16 and 18. The wrench housing halves 20a have a bi-lateral or cross wise groove on the bottom handle have 20b so that the adjusting collar 24 rides and adjusts axially within the center of both the upper 20a and lower 20b handle haves; when a particular wrench is selected, the user slides the cylindrical collar 24 either forward for a particular wrench 12, 14, 16 or 18 size needed or reverse for the opposite wrench size selection. Constant tension is applied by four tiered détente ball bearings 32b which are influenced by four tiered compression springs 32c; said springs 32c and the détente spherical ball bearings 32b are housed in the central pillar 32a tiered pockets; when the user selects one of the four tiered wrenches 12, 14, 16 or 18 by rotation of the cylindrical collar 24 he or she then slides the selected wrench either forward or backwards, the détente steel ball bearing 32b, at that particular tier of the support pillar 32, the spherical ball bearing falls into a selected wrench into the outer crosswise node which is influenced by the springs 32c pressure behind the spherical ball 32b; the selected extended wrench is then secured into the extended working position; each of the four wrenches 12, 14, 16 & 18 have three internally longitudinal edge spherical notches 12d, 14d, 16d & 18d within their longitudinal channels to retain the wrenches in either a mid or extended forward or reverse position.

The exterior cylindrical collar 24 has first activating dowel pin 24b and a second activating dowel pin 24c that capture the collars wrench support inserts 28a left and 28b right that follow the longitudinal limit path of the slide four tiered wrenches longitudinal slots at the lower cylindrical half handle 20b; collar 24 has a third and main capturing pin 26 that axially rotatable and captures the mid cross section notch of any of the four tied wrenches. Guide pin 24c follows the path of any of the four spaced longitudinal channels at the bottom half handle 20b. The exterior track of the bottom half handle 20b is longitudinally grooved 20e to guide a selected wrench 12, 14, 16 or 18, influenced by dowel pins 24c in either a forward or reversed direction depending on the need of a selected wrench. The top handle half 20a has size indicia indicating the range of the four tiered wrenches 12— 5/16-⅜, 14— 7/16-½, 16— 9/16-⅝ and 18— 11/16-¾; The slide wrench bottom half 20b has four longitudinal guide tracks 20d that correspondently align with the orientation of each selected longitudinal guide lines on 20a top handle half that correspond with wrenches 12, 14, 16 & 18 and align with the slide wrench top handle half 20a.

What is claimed is:

1. A multi-tiered wrench set comprising:
an upper and lower cylindrical housing halves having a longitudinal axis, and a central connecting pillar that retains and supports a plurality of four stacked wrenches having first and second end positions within said housing halves, said wrenches being slideable along the longitudinal and horizontally in either forward or reverse direction, each wrench having a longitudinal slot formed therein; and means attached to said wrenches to allow a selected wrench to be expanded outward in either a forward or reverse direction.

2. The wrench set of claim 1 wherein each plurality of wrenches has a hexagonal configured open end positioned at the first end.

3. The wrench set of claim 2 wherein a plurality of wrenches has a hexagonal configured open end positioned at both ends.

4. The wrench set of claim 3 further includes at least one guide pin positioned within any of the four exterior bottom handle half slots.

5. The wrench set of claim 4 wherein the four stacked wrenches each contain a longitudinal slotted channel, and guided by the central pillar that connects both the upper and lower cylindrical handle halves and guides the four stacked wrenches.

6. The wrench set of claim 5 further includes a three cross wise nodes are spaced equally and within the longitudinal channel slot of the four stacked wrenches; the three spaced nodes capture the détente steel ball bearings, influenced by the compression spring bias and thus locks the tiered wrenches in the selected extended position(s)

7. The wrench set of claim 6 further includes cylindrical collars that fits diametrically over the upper and lower cylindrical handle halves, and rides laterally forward or reverse influencing a selected tiered wrench to move simultaneously to the collar.

8. The wrench set of claim 7 further includes an internal arm within the cylindrical collar that activates, rotationally, any of the selected four stacked wrenches at their central crosswise notches; as the said internal collar arm captures that selected wrench which the user glides the cylindrical outer ring either forward or reverse to influence the selected wrench to move and lock forward or reverse for a particular size socket wrench opening.
